(19) United States
(12) Patent Application Publication
(10) Pub. No.: US 2014/0372410 A1
(43) Pub. Date: Dec. 18, 2014

(54) UPPER BOUNDS FOR MATCHING

(71) Applicant: MICROSOFT CORPORATION, Redmond, WA (US)

(72) Inventors: MATTHEW G. HUMPHREY, ISSAQUAH, WA (US); NITIN VED, REDMOND, WA (US)

(21) Appl. No.: 13/917,802

(22) Filed: Jun. 14, 2013

(51) Int. Cl. G06F 17/30

(52) U.S. Cl. CPC G06F 17/30424
USPC 707/722

(57) ABSTRACT

Methods, computer systems, and computer-storage media are provided for refining results. In order to display accurate counts for refinements, an upper bound may be assigned to the refinements such that one the upper bound is reached, counts no longer need to be generated for that refinement. This allows for more accurate counting of all of the refinements if dominating refinements are limited at an upper bound. Once the upper bound is reached, the refinement is no longer counted and the remaining time allowed to count refinements is utilized to count the remaining refinements.

### BACKGROUND

Due to performance constraints and a large number of documents in today's search engines, algorithms used to match documents are optimized such that they only review a subset of the complete set of matching documents. Some scenarios, however, require that documents that are matched include a representative sample of those associated with each value or range of values of some attribute of the documents. Given the large number of documents available to go through, it is common for the sample to be inaccurate or completely missed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments of the present invention relate to systems, methods, and computer-storage media for, among other things, refining results. The present invention seeks to determine accurate counts for any value associated with a result including, for example, a document. Upper bounds may be established when reviewing a set of documents such that dominant matches may be ignored after the upper bound is met. In other words, when counting a number of documents that match a refinement, an upper bound (e.g., a maximum count) is established such that once the upper bound is reached no additional counts are updated for that refinement. This allows for refinements with smaller counts to have more accurate totals since there is more focus on the less dominant refinements.

Accordingly, in one embodiment, the present invention is directed to one or more computer-storage media having computer-executable instruction embodied thereon that, when executed by one or more computing devices, perform a method of refining results. The method comprises, identifying a plurality of refinements associated with a search query, identifying an upper bound for each refinement of the plurality of refinements, and removing at least one refinement of the plurality of refinements once the upper bound is reached such that counts are no longer updated for the at least one refinement.

In yet another embodiment, the present invention is directed to a computer system for refining results. The system comprises a computing device associated with a refining engine having one or more processors and one or more computer-storage media and a data store coupled with the refining engine, where the refining engine identifies a plurality of refinements associated with a search query, identifies an upper bound for each refinement of the plurality of refines, and removes the at least one refinement of the plurality of refinements once the upper bound is reached such that counts are no longer updated for the at least one refinement.

In another embodiment, the presented invention is directed to one or more computer-storage media having computer-executable instruction embodied thereon that, when executed by one or more computing devices, perform a method of refining results. The method comprises receiving a search query input, identifying a plurality of refinements associated with the search query, identifying an upper bound for each refinement of the plurality of refinements, removing at least one refinement of the plurality of refinements to be updated such that counts for the at least one refinement are no longer updated, and updating counts for each of the remaining refinements until one of an expiration of a predetermined time period or exceeding the upper bound.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary system for refining results suitable for use in implementing embodiments of the present invention;

FIG. 3 is a flow diagram of an exemplary method of refining results in accordance with an embodiment of the present invention; and

FIG. 4 is a flow diagram of an exemplary method of refining results in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Various aspects of the technology described herein are generally directed to systems, methods, and computer-storage media for, among other things, refining results. As mentioned, the present invention seeks to determine accurate counts for any value associated with a result including, for example, a document. Upper bounds may be established when reviewing a set of documents such that dominant matches may be ignored after the upper bound is met. In other words, when counting a number of documents that match a refinement, an upper bound (e.g., a maximum count) is established such that once the upper bound is reached no additional counts are updated for that refinement. This allows for refinements with smaller counts to have more accurate totals since there is more focus on the less dominant refinements. Put simply, dominant refinements (i.e., refinements with a large number of matches) will not be focused on very long as the upper bound will quickly be met and matches will no longer be counted for the dominant refinement.

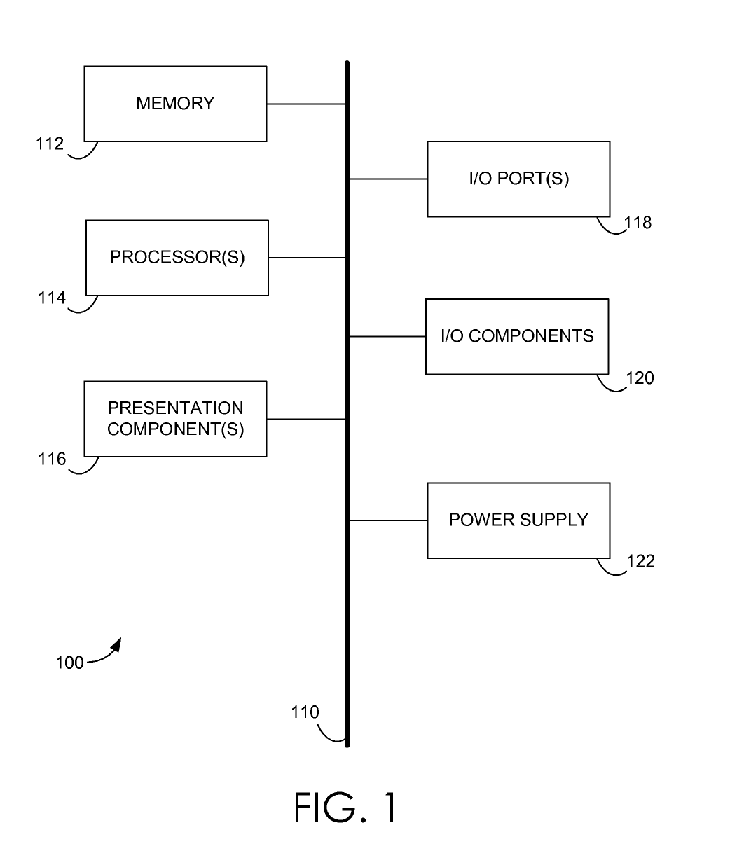

Having briefly described an overview of embodiments of the present invention, an exemplary operating environment in which embodiments of the present invention may be implemented is described below in order to provide a general context for various aspects of the present invention. Referring to the figures in general and initially to FIG. 1 in particular, an exemplary operating environment for implementing embodiments of the present invention is shown and designated generally as computing device 100. The computing device 100 is but one example of a suitable computing environment and is not intended to suggest any limitation as to the scope of use or functionality of embodiments of the invention. Neither should the computing device 100 be interpreted as having any dependency or requirement relating to any one or combination of components illustrated.

Embodiments of the invention may be described in the general context of computer code or machine-useable instructions, including computer-useable or computer-executable instructions such as program modules, being executed by a computer or other machine, such as a personal data assistant, a smart phone, a tablet PC, or other handheld device. Generally, program modules including routines, programs, objects, components, data structures, and the like, refer to code that performs particular tasks or implements particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With continued reference to FIG. 1, the computing device 100 includes a bus 110 that directly or indirectly couples the following devices: a memory 112, one or more processors 114, one or more presentation components 116, one or more input/output (I/O) ports 118, one or more I/O components 120, and an illustrative power supply 122. The bus 110 represents what may be one or more busses (such as an address bus, data bus, or combination thereof). Although the various blocks of FIG. 1 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media may be any available media that is accessible by the computing device 100 and includes both volatile and nonvolatile media, removable and non-removable media. Computer-readable media comprises computer storage media and communication media; computer storage media excludes signals per se. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computing device 100. Communication media, on the other hand, embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The memory 112 includes computer-storage media in the form of volatile and/or nonvolatile memory. The memory may be removable, non-removable, or a combination thereof. Exemplary hardware devices include solid-state memory, hard drives, optical-disc drives, and the like. The computing device 100 includes one or more processors that read data from various entities such as the memory 112 or the I/O components 120. The presentation component(s) 116 present data indications to a user or other device. Exemplary presentation components include a display device, speaker, printing component, vibrating component, and the like.

The I/O ports 118 allow the computing device 100 to be logically coupled to other devices including the I/O components 120, some of which may be built in. Illustrative I/O components include a microphone, joystick, game pad, satellite dish, scanner, printer, wireless device, a controller, such as a stylus, a keyboard and a mouse, a natural user interface (NUI), and the like.

A NUI processes air gestures, voice, or other physiological inputs generated by a user. These inputs may be interpreted as search prefixes, search requests, requests for interacting with intent suggestions, requests for interacting with entities or subentities, or requests for interacting with advertisements, entity or disambiguation tiles, actions, search histories, and the like presented by the computing device 100. These requests may be transmitted to the appropriate network element for further processing. A NUI implements any combination of speech recognition, touch and stylus recognition, facial recognition, biometric recognition, gesture recognition both on screen and adjacent to the screen, air gestures, head and eye tracking, and touch recognition associated with displays on the computing device 100. The computing device 100 may be equipped with depth cameras, such as, stereoscopic camera systems, infrared camera systems, RGB camera systems, and combinations of these for gesture detection and recognition. Additionally, the computing device 100 may be equipped with accelerometers or gyroscopes that enable detection of motion. The output of the accelerometers or gyroscopes is provided to the display of the computing device 100 to render immersive augmented reality or virtual reality.

Aspects of the subject matter described herein may be described in the general context of computer-executable instructions, such as program modules, being executed by a computing device. Generally, program modules include routines, programs, objects, components, data structures, and so forth, which perform particular tasks or implement particular abstract data types. Aspects of the subject matter described herein may also be practiced in distributed computing environments where tasks are performed by remote processing devices that are linked through a communications network. In a distributed computing environment, program modules may be located in both local and remote computer storage media including memory storage devices.

Furthermore, although the term “server” is often used herein, it will be recognized that this term may also encompass a search engine, a Web browser, a cloud server, a set of one or more processes distributed on one or more computers, one or more stand-alone storage devices, a set of one or more other computing or storage devices, a combination of one or more of the above, and the like.

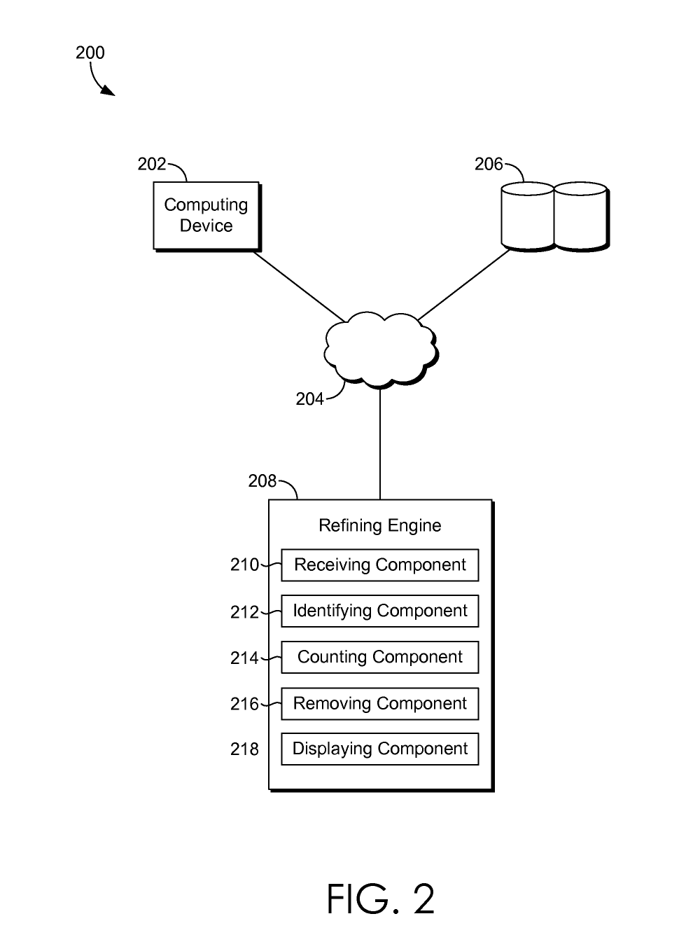

Referring now to FIG. 2, a block diagram is provided illustrating an exemplary computing system 200 in which embodiments of the present invention may be employed. Generally, the computing system 200 illustrates an environment where results are refined using refinements. Refinements, as used herein, generally refers to one or more narrowing features to narrow down a large set of items that match a search query into a smaller set of items that match the search query. Items may be documents, web pages, web sites, images, videos, and the like. Refinements are typically used by a user to narrow down searches such that, for example, a search query is input and a set of search results are returned but the user would like to narrow the search results so they select a refinement that may be displayed in conjunction with the search results such that a refined set of matches is now displayed. As a practical example, assume a search query input for an electronic device is input. Exemplary refinements may include, but are not limited to, brands (i.e., different brands/manufacturers of the electronic device), price ranges (e.g., various options may exist for the electronic device that are in the, for example, $0-50 range while there may be some options in the $500-1000 range), colors, and the like.

An additional example would be a user shopping for clothing. A clothing item may be input (such as, for example, a shoe) and exemplary refinements may include brand, price range, color, size, retailer, and the like.

Typically, the refinements are displayed to a user in conjunction with one or more search results. The refinements may indicate a number of matches, or counts, that is associated with the refinement. For instance, using the above example of a user buying shoes, the refinement for brand may indicate that, of the displayed search results, 15 are matches for Brand A while only 5 are matches for Brand B. A user may then select the refinement in order to see only the refined results, rather than all of the search results.

The problem with the existing technology is that the counts are typically inaccurate. For example, a refinement may be associated with a low count and when the user selects the refinement and a different number of matches are displayed (e.g., a much larger number than indicated by the count) such that the user is dissatisfied. Additionally, refinements with very low counts may not even show up to a user as they may not have been identified in a time provided by the system.

Referring back to FIG. 2, among other components not shown, the computing system 200 generally includes a computing device 202, a network 204, a database 206, and a refining engine 208. The computing device 202 may be a device similar to that illustrated in FIG. 1.

The network 204 may include, without limitation, one or more local area networks (LANs) and/or wide area networks (WANs). Such networking environments are commonplace in offices, enterprise-wide computer networks, intranets and the Internet. Accordingly, the network 204 is not further described herein.

The refining engine 208 may include a receiving component 210, an identifying component 212, a counting component 214, a removing component 216, and a displaying component 218. The receiving component 210 may be configured for, among other things, receiving a search query input. The search query input may be received from a user.

The identifying component 212 may be configured for, among other things, identifying one or more refinements associated with the search query input. The one or more refinements may be, as mentioned previously, one or more brands, one or more price ranges, colors, sizes, retailers, and the like. The identifying component 212 may also be configured for identifying an upper bound to be associated with each refinement. For instance, the identifying component 212 may identify that an upper bound of 100, for example, is appropriate, given the search query input. An upper bound, as used herein, refers generally to a maximum number of matches identified before the system 200 stops identifying matches for the associated refinement. Upper bounds may vary for each search query input. For instance, a search query input for X may have refinements associated with upper bounds of 50 while a search query input for Y may have refinements associated with upper bounds of 100. This is a determination made by the system 200 based on what is practical to match within a predetermined time limit.

The counting component 214 may be configured for, among other things, counting one or more matches for one or more refinements. The counting component 214 may be any counting mechanism known in the art. The counting component 214 may be configured to initiate a count automatically upon receiving a search query input and identified refinements being available or may initiate a count upon receiving an indication from the system 200.

The removing component 216 may be configured for, among other things, removing a refinement from a refining search. The removing component 216 may remove refinements upon identifying that an upper bound for the refinement has been reached. For instance, if an upper bound for Brand X is 50, the removing component 216 will remove Brand X from the refinement query once 50 matches have been identified or counted. Once the upper bound is reached, an estimated count may be provided.

The displaying component 220 may be configured for, among other things, displaying the one or more refinements. The displaying component 220 may display the one or more confinements in conjunction with one or more search results associated with a search query input. The displaying component 220 may also display a count associated with each of the one or more refinements. The one or more refinements may be displayed as selectable such that, upon selection thereof, a user may view the refined results.

In application, a user may enter a search query input. Upon receiving the search query input, one or more search results may be generated. In addition, one or more refinements that may be associated with the search query input may be identified. For instance, if the search query input is for an item that a user wears, size may be an appropriate refinement. On the other hand, size may not be appropriate when searching for cleaning supplies.

Based on the search query input, an upper bound may be identified for each of the one or more refinements. An upper bound may be identified based on what is practical to match within a search query. For instance, an upper bound may be lower in an area that includes several possible refinements while an upper bound may be higher when there are not as many refinements to search. Alternatively, upper bounds may be set based on one or more database references such that historical matches for one or more refinements may be used in order to estimate how dominant the refinement is. For instance, if a refinement is associated with a very large number of matches in an index, the refinement may be identified as a dominant refinement and the upper bound may be lower for the dominant refinement such that it doesn't occupy resources throughout a predetermined time limit available, or any other limit (predetermined or dynamically computed), to search for refinement matches. The predetermined time limit may be any amount of time designated by a system administrator. Likely, the predetermined time limit is not a large amount of time as results should be returned to users very quickly. In an embodiment, each document matching the search query input is reviewed before stopping, rather than using a predetermined time limit. The review may end when the review of all documents is complete or when any other predetermined or computed time limit is reached. Additionally, other parameters may be used to stop the review such as, for example, a total number of documents found to match a search query input or any other parameter that seems applicable to a system administrator.

When the upper bound is exceeded, matches are no longer identified or counted and the refinement is removed from consideration. Once matches are no longer identified or counted, the count returned for that refinement is an estimate. The system is free to then move on to finding matches for the remaining refinements such that refinements with a lower number of matches are reviewed. Refinement values, or counts, may be exact for refinements having a small number of matches.

Multiple searches for refinements may be performed. For instance, a refinement of brand and color may be simultaneously searched. The counts are structured the same way as previously described such that once an upper bound is reached for a refinement (regardless of which refinement category the refinement is in (e.g., brand, color, etc.)), the refinement is removed such that matches are no longer identified.

Regardless of the refinement narrowing, search query results may not be changed by the refinement matching. The two queries may be run simultaneously. While the initial search query results are not altered by the refining, once a user selects a refinement, the results displayed to a user are then narrowed to only those associated with the selected refinement.

In an embodiment, refinements may be optimized. This is applicable to, for example, price ranges. The system 200 may store an index of various price ranges such that a variety of ranges are available. This ensures that the most relevant price ranges are utilized. For example, for Item A, price ranges may exist for $0-5000, $0-1000, $1000-2000, $2000-3000, $3000-4000, and $4000-5000. Depending on the query, it may be more appropriate to use a very large range of $0-5000 and $5000-10,000 or it may be more appropriate to use the smaller ranges of $0-1000, $1000-2000, $2000-3000, $3000-4000, $4000-5000, and the like.

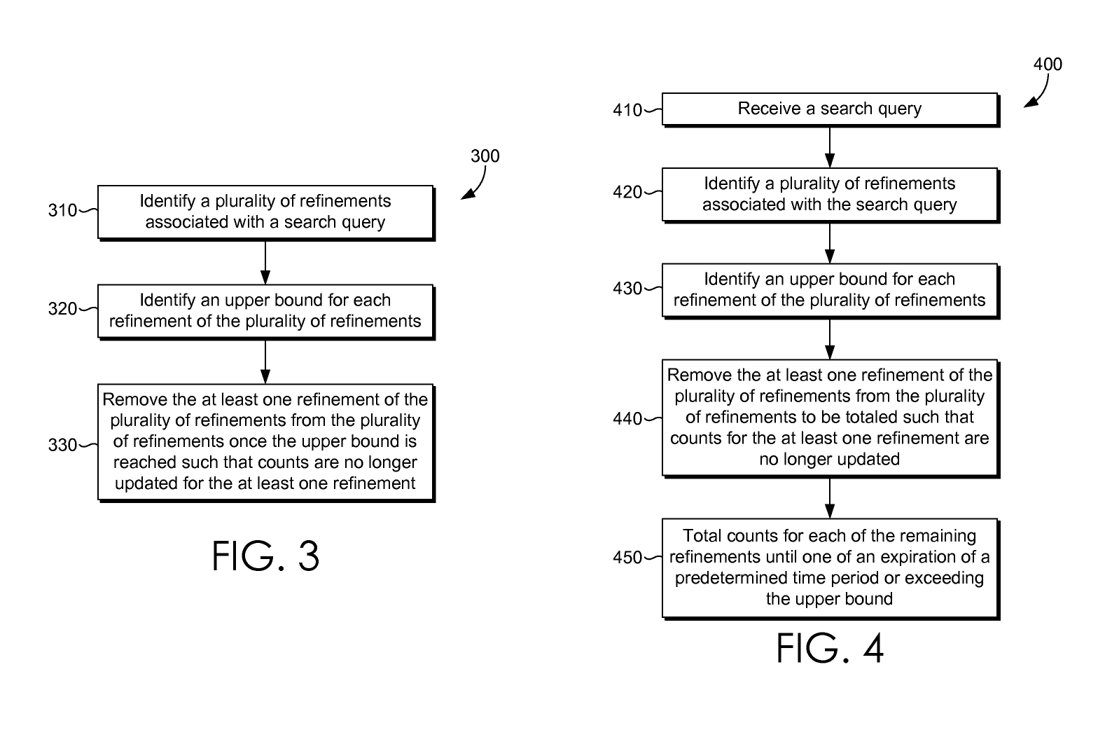

Turning now to FIG. 3, a process-flow diagram, referenced generally by the numeral 300, is depicted illustrating a method of refining results. At block 310, a plurality of refinements associated with a search query is identified. An upper bound associated with each refinement of the plurality of refinements is identified at block 320. At block 330, at least one refinement of the plurality of refinements is removed once the upper bound is reached such that counts are no longer updated for the at least one refinement that has been removed.

Turning now to FIG. 4, a flow diagram is depicted of an exemplary method 400 of refining results. At block 410, a search query input is received. A plurality of refinements associated with the search query input is identified at block 420 as well as an upper bound being identified for each refinement at block 430. At least one refinement is removed at block 440 when an upper bound is reached such that counts for the at least one refinement are no longer updated. Counts for the remaining refinements are updated until one of an expiration of a predetermined time period or exceeding the upper bound.

The present invention has been described in relation to particular embodiments, which are intended in all respects to be illustrative rather than restrictive. Alternative embodiments will become apparent to those of ordinary skill in the art to which the present invention pertains without departing from its scope.

What is claimed is:

1. One or more computer-storage media having computer-executable instructions embodied thereon that, when executed by one or more computing devices, perform a method of refining results, the method comprising:
identifying a plurality of refinements associated with a search query, wherein a refinement is an identifier that narrows the search query;
identifying an upper bound for each refinement of the plurality of refinements, wherein the upper bound is a predetermined maximum threshold of documents to identify as associated with at least one of the plurality of refinements; and
removing the at least one refinement of the plurality of refinements from the plurality of refinements once the upper bound is reached such that counts are no longer updated for the at least one refinement.

2. The media of claim 1, further comprising updating counts for each of the remaining plurality of refinements until a predetermined time period has elapsed.

3. The media of claim 1, further comprising displaying the counts for each of the plurality of refinements to a user.

4. The media of claim 1, further comprising displaying the counts for each of the plurality of refinements to a user in combination with search results associated with the search query.

5. The media of claim 1, wherein at least one of the plurality of refinements is a brand of an item.

6. The media of claim 1, wherein at least one of the plurality of refinements is a price range.

7. The media of claim 1, further comprising receiving a selection of at least one refinement of the plurality of refinements.

8. The media of claim 7, further comprising displaying narrowed refinement results in response to receiving the selection of the at least one refinement.

9. A system for refining results, the system comprising:
a computing device associated with a refining engine having one or more processors and one or more computer-storage media; and
a data store coupled with the refining engine,
wherein the refining engine:
identifies a plurality of refinements associated with a search query, wherein a refinement is an identifier that narrows the search query;
identifies an upper bound for each refinement of the plurality of refinements, wherein the upper bound is a predetermined maximum threshold of documents to identify as associated with at least one of the plurality of refinements; and
removes the at least one refinement of the plurality of refinements from the plurality of refinements once the upper bound is reached such that counts are no longer updated for the at least one refinement.

10. The system of claim 9, wherein the refining engine further updates counts for each of the plurality of refinements remaining until a predetermined time period has elapsed.

11. The system of claim 9, wherein the refining engine further displays the counts for each of the plurality of refinements to a user.

12. The system of claim 9, wherein the refining engine further displays the counts for each of the plurality of refinements to a user in combination with search results associated with the search query.

13. The system of claim 9, wherein at least one of the plurality of refinements is a brand of an item.

14. The method of claim 9, wherein at least one of the plurality of refinements is a price range.

15. The method of claim 9, wherein the refinement engine further receives a selection of at least one refinement of the plurality of refinements.

16. The method of claim 15, wherein the refinement engine further displays narrowed refinement results in response to receiving the selection of the at least one refinement.

17. One or more computer-storage media having computer-executable instructions embodied thereon that, when executed by one or more computing devices, perform a method of refining results, the method comprising:
receiving a search query input;
identifying a plurality of refinements associated with the search query, wherein a refinement is an identifier that narrows the search query;
identifying an upper bound for each refinement of the plurality of refinements, wherein the upper bound is a predetermined maximum threshold of items to identify as associated with at least one of the plurality of refinements;
removing at least one refinement of the plurality of refinements from the plurality of refinements to be counted when the upper bound is exceeded such that counts for the at least one refinement are no longer updated; and
updating counts for each of the remaining refinements until one of an expiration of a predetermined time period or exceeding the upper bound.

18. The media of claim 17, wherein a second refinement is removed from the plurality of refinements to be updated upon reaching the upper bound for the second refinement such that counts for the second refinement are no longer updated.

19. The media of claim 18, wherein each of the remaining refinements, excluding the at least one refinement and the second refinement, are updated until expiration of the predetermined time period.

20. The media of claim 17, wherein at least one of the plurality of refinements is a brand of an item.
